(19) United States
(12) Patent Application Publication
(10) Pub. No.: US 2026/0234749 A1
(43) Pub. Date: Aug. 13, 2026

(54) PROCESS FOR EXTRACTING METALS FROM LITHIUM-ION BATTERIES

(71) Applicant: ARABAT S.R.L., Foggia (IT)

(72) Inventors: Raffaele NACCHIERO, Foggia (IT); Giovanni MICCOLIS, NOCI (BA) (IT); Vincenzo SCARANO, Foggia (IT); Leonardo RENNA, Fasano (IT); Leonardo BINETTI, Edinburgh (GB); Matteo FRANCAVILLA, San Severo (FG) (IT)

(73) Assignee: ARABAT S.R.L., Foggia (IT)

(21) Appl. No.: 19/156,079

(22) PCT Filed: Feb. 19, 2024
(86) PCT No.: PCT/IB2024/051557

§ 371 Date: Aug. 13, 2025

(30) Foreign Application Priority Data
Feb. 17, 2023 (IT) 102023000002784

(51) Int. Cl. C22B 7/00; B01D 69/02; B01D 71/56; C01D 7/26; C01D 15/08; C01G 45/03; C01G 51/05; C01G 53/05; C22B 1/248; C22B 3/00; C22B 3/16; C22B 3/22; C22B 3/44; C22B 47/00; H01M 10/54

(52) U.S. Cl. CPC C22B 7/007; B01D 69/02; B01D 71/56; C01D 7/26; C01D 15/08; C01G 45/03; C01G 51/05; C01G 53/05; C22B 1/248; C22B 3/165; C22B 3/22; C22B 3/44; C22B 23/0415; C22B 23/0461; C22B 47/00; H01M 10/54; B01D 2325/02834

(57) ABSTRACT

A process for the extraction of metals from lithium-ion batteries involves the preparation of a battery with charge zeroing, and the separation of the copper from the other components generating the by-product to be recovered: following the size reduction of the by-product, the crushed by-product is leached into an aqueous solution admixed with natural organic acids with a concentration≤0.9 M and recovery reducing agents, said aqueous solution and dimensionally reduced by-product which may be assisted by sonication with ultrasound and/or microwaves in a container for a time between 30 minutes and 60 minutes at a temperature between 25° C. and 90° C. so as to obtain a leaching solution, wherein said recovery reducing agents are derived from the drying and crushing of vegetable/plant products.

### CROSS-REFERENCE TO RELATED APPLICATIONS

This application is a § 371 U.S. National Phase of PCT/IB2024/051557, filed Feb. 19, 2024, which claims priority of Italian Patent Application No. 102023000002784, the entire contents of all of which are incorporated by reference herein as if fully set forth.

### FIELD OF THE INVENTION

The present invention has as its object a process for extracting metals from lithium-ion batteries with reduced environmental impact.

In particular, a process for leaching metals from lithium-ion batteries using reducing agents obtained from plant products, i.e., vegetable and fruit waste.

### BACKGROUND

Lithium-ion batteries (LIBs) have become the most common energy storage and energy conservation technology and are currently the fastest growing sector of the battery market. Demand for LIBs has been estimated to grow about 10-fold by 2025, mainly driven by the increasing popularity of electric vehicles and the growing applications of energy storage and accumulation generated from renewable sources.

However, this exponential growth has generated concerns in terms of the availability and supply of the materials needed to make lithium batteries. For this reason, and with a view to realize tangible circular economy processes, the recycling and recovery of spent LIB batteries is a promising approach to solve problems concerning the availability of LIB raw materials.

From a purely economic point of view, LIB recovery is mainly related to the recovery of the economically valuable metals that make up the cathode component: lithium and transition metals such as nickel, manganese and cobalt. From an environmental point of view, the management and disposal of spent LIBs represents a serious environmental problem and a great danger to human health.

The material of which the cathode of a LIB battery is made can generally be represented by the following molecular formula: LiNixMnyCozO2, with 0<x, y, z<1, and x+y+z=1, and referred to as NMC (Nickel, Manganese, Cobalt). Other examples of LIBs are LMOs (Lithium, Manganese, Oxygen) with the formula LiMn₂O₄ and the more common LCOs (Lithium, Cobalt, Oxygen) with the formula LiCoO₂.

The metals that make up the cathode material are held together by a binder. Polyvinylidene fluoride (PVDF) is the most commonly used polymer as a binder both to hold the cathode metal particles together and to bond the cathode material to the current collector, usually an aluminum foil.

PVDF has strong chemical corrosion resistance and thermal resistance, and provides high bond strength. However, it can be a source of worrying releases of toxic fluorinated compounds during battery recycling processes.

Several approaches have been proposed in the literature to deactivate PVDF and recover the cathode material, which include direct calcination, solvent dissolution, and treatment with molten salts.

Direct calcination decomposes PVDF at temperatures of 400-500° C., which requires high energy consumption. In addition, it results in the formation of hydrofluoric acid (HF), a gas that has negative effects on both air quality and human health.

Organic solvent dissolution utilizes the solubility of PVDF in organic solvents to obtain and separate the cathode material from the aluminum foil used as a current collector. Organic solvents such as N-methyl-2-pyrrolidone (NMP) and N—N-dimethylformamide (DMF) were used to dissolve PVDF. However, the volatilization/evaporation of these toxic organic solvents limits their applications in large-scale plants. Other green solvents such as ethylene glycol and choline glycerol chloride are used to reduce environmental impacts but, in these cases, additional treatments such as mechanical crushing to reduce particle size are required.

In this respect, several studies have employed weak organic acids such as citric acid, malic acid, succinic acid, and tartaric acid to replace strong acids in the metal leaching process. These weak organic acids have proven to have a competitive leaching performance.

In particular, with the help of 0.5-15 vol % of H₂O₂, which acts as a reducing agent, the resulting H₂O₂-weak organic acid combination can extract up to >95% of the metals from spent LIB waste.

In the article Xiong Xiao et al. (Ultrasound-assisted extraction of metals from Lithium-ion batteries using natural organic acids, Green Chem., 2021, 23, 8519-8532), it was also shown that ultrasound-assisted leaching can significantly improve the efficiency of the system, resulting in a metal ion recovery of 97% (higher values were obtained for cobalt and nickel, reaching >99%, while lithium and manganese were recovered with an efficiency of 94-96%).

In addition to that, a significant improvement was achieved in process times, which were reduced by over 50%. One of the disadvantages of weak acids is the need to add H₂O₂, which causes concern due to its explosive chemical state and chemically unstable nature, leading to the search for more environmentally friendly alternatives to replace H₂O₂ in this hydrometallurgy-based process.

For these reasons, alternative solutions based on the reuse of food waste as leaching reducing agents have been postulated.

Chen et al. (Sustainable Recovery of Metals from Spent Lithium-Ion Batteries: A Green Process, Article in ACS Sustainable Chemistry & Engineering, November 2015) proposed one of the first green leaching processes based on using a biomass such as tea in combination with citric acid. The general idea of the study was to exploit the lignocellulosic component present in plant waste that can decompose into reducing sugars such as d-glucose, fructose, and arabinose, which would then serve as reductants in the redox-based metal dissolution process.

Over time, several studies have been conducted to explore the beneficial reducing properties of biomass. In addition to tea, maize, sugar cane and grape seeds have also been the objects of analysis.

Wu et al. (Repurposing of Fruit Peel Waste as a Green Reductant for Recycling of Spent Lithium-Ion Batteries, Environ. Sci. Technol. 2020, 54, 9681-9692, https://dx.doi.org/10.1021/acs.est.0c02873) recently tested and reported on the use of citric acid (H3Cit) as a leaching agent in combination with the use of orange peel (OP) as a green reducing system to extract and recover metals (Ni, Co, Mn and Li) from what they call ‘LIB black mass’. In the aforementioned work, the authors optimize the leaching conditions (5 g black mass, 100° C. for 4 h, 1 g OP, 100 mL H3Cit 1.5M) and the metal recovery conditions by selective precipitation of the respective hydroxides by addition of NaOH and temperature control.

According to a study, described in Canadian Patent Application No. 3,124,418 A1, the optimal leaching conditions that allowed a yield of more than 80% were as follows: 100° C. for the leaching temperature, 200 mg OP, 1.5 M citric acid, 4 h for the leaching time and 25 g L⁻¹ for the LIB black mass slurry density to obtain metal compounds.

In the case of patent application No. CN 112 501 442 A, the authors use a mix of OP and citric acid (1:2 ‘mass ratio’), where the citric acid is produced in-house by them. Then, 1:(50-60) ‘mass ratio’ of lithium battery powder is mixed with the previously mentioned OP and citric acid solution, plus between 0.1 and 5% catalyst is also added to obtain lithium, cobalt, nickel and manganese metal.

In the case of patent application CN 113 528 832 A, the use of orange juice and juice derived from orange peel to leach lithium iron phosphate and lithium cobalt oxide was described.

US Patent Application No. 2022/0136079 A also covers a leaching process using fruit waste as raw material for the reducing elements to be added to the solution.

The use of citric acid as a leaching agent and fruit and vegetable scraps as a raw material from which to extract the organic reducing agent required for metal extraction and recovery was found to be effective, and with a reduced environmental impact, in the context of a circular economy of raw material recovery and waste utilization.

However, a chemical process using recovered materials requires an extensive experimental campaign to optimize the yield of such a process and to identify the most suitable raw material and the optimal values of the process parameters.

In addition, leaching processes usually require very long lead times and thus costs in terms of the recovery plant.

The technical problem underlying the present invention is to provide a process for the extraction of metals from lithium-ion batteries, which can overcome the drawbacks mentioned with reference to the known technique.

### SUMMARY

This problem is solved by a process for the extraction of metals from lithium-ion batteries that involves preparing a lithium-ion battery by zeroing the charge by immersion in an aqueous NaCl solution and separating a copper element included in said battery from the rest of its components. The components are generally identified as a by-product and can be polyvinylidene fluoride (PVDF), polyethylene (PE), Al, cathode material, anode material.

Once the by-product has been isolated, its size reduction is carried out before proceeding to the leaching step, which involves introducing the by-product into an aqueous solution additivated with natural organic acids with a concentration 0.9 M and recovering reducing agents, said aqueous solution and crushed by-product are agitated in a container for between 30 minutes and 60 minutes at a temperature between 25° C. and 90° C., preferably 80° C., in order to obtain a leaching solution. The leaching step is assisted by sonication with ultrasound and/or microwaves. The reducing agents used are derived from the drying and pulverization of plant products such as edible vegetable scraps and/or fruit scraps, in particular artichoke, fennel, sea fennel, cabbage, carrot, asparagus, broccoli, clove, ginger, cinnamon, turmeric, mustard, curry, paprika, chili, pepper, parsley, molasses, oregano, orange, lemon, blueberry, cherry, strawberry and the like.

Of these products, scraps of artichoke (Cynara cardunculus scolymus) and sea fennel (Crithmum maritimum) were found to be particularly functional in the process according to the invention, and the use of orange scraps, peels in particular, was also found to be particularly beneficial.

Preferably, artichoke waste are involucral artichoke bracts, often identified as leaves although they are part of the artichoke flower, part of which is edible.

At the end of the leaching phase, the PVDF and PE are separated from the by-product by centrifugation and the remaining solution is filtered to remove solid residues.

The metals are then extracted through three precipitation steps: a first precipitation step involves raising the pH of the leaching solution to 12 through the addition of KOH and holding the solution for between 20 minutes and 40 minutes at a temperature of between 60° C. and 90° C., preferably 80° C., in order to obtain precipitates of Ni(OH)₂ and Mn(OH)₂.

In order to separate the precipitates from the solution, the latter is filtered to pass to the second precipitation step in which the leaching solution is kept at pH=12 by appropriately dosing the KOH concentration, and to which pure ethanol is added in order to obtain precipitated Co(OH)₂ and supernatant, the Co(OH)₂ being recovered by centrifugation of the solution.

Finally, a third precipitation step in which the supernatant obtained downstream of the second precipitation step is insufflated with gaseous CO2 to obtain Li2CO3 precipitate.

The main advantage of the process according to the present invention lies in the use of readily available plant products, such as artichoke and sea fennel waste, as reducing agents. In fact, the use of vegetable waste, in short vegetable scraps, fits into a circular economy and recovery context which aims to valorize waste. In addition, the use of said vegetable waste in combination with natural organic acids, in particular citric acid, makes it possible to reduce operating times and temperatures compared to other known state-of-the-art leaching methods, with a reduction in process costs linked to the reduction in energy consumption of the blowing system.

Another and not insignificant advantage of the process lies in the use of CO₂ for the recovery of Li as carbonate, which turns out to be an efficient storage system for CO₂ which is one of the main greenhouse gases and the cause of current climate change.

A further advantage is that the leaching phase is assisted by sonication with ultrasound and/or microwaves, which, as experimentally verified, improves the leaching efficiency of the solution under the same conditions.

A variant of the invention involves using orange scraps, preferably orange peels, in combination with artichoke scraps.

### BRIEF DESCRIPTION OF THE DRAWINGS

The present invention will hereinafter be described according to its preferred examples of embodiment, provided for illustrative and non-limiting purposes with reference to the accompanying drawings in which:

FIG. 1 shows a block diagram of the process according to the invention.

FIG. 2 shows a lithium-ion battery of those treated with the process as in FIG. 1.

FIG. 3 shows a graph with results on the leaching efficiency of the process in some of its realizations.

### DETAILED DESCRIPTION OF THE PREFERRED EMBODIMENTS

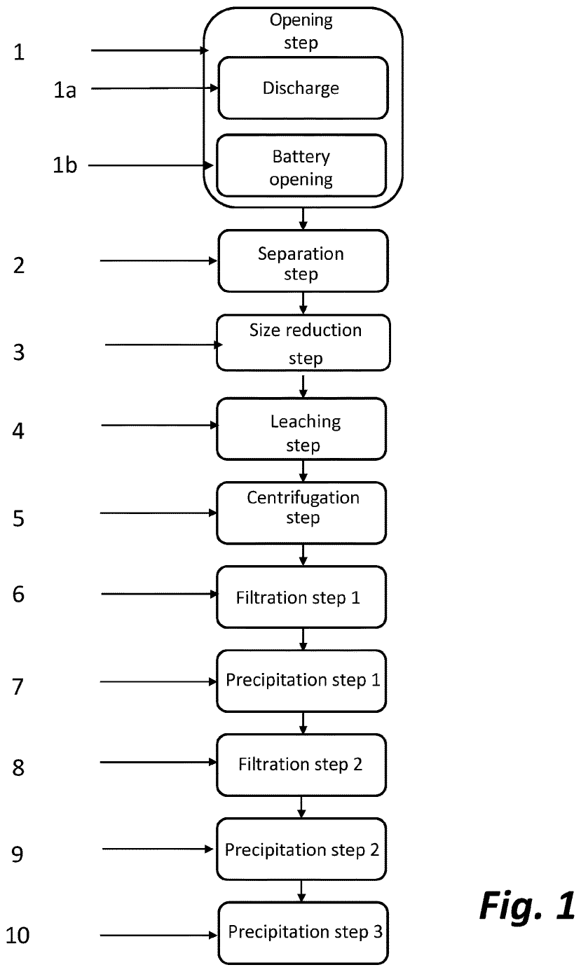

FIG. 1 shows an early form of a process for the extraction of metals from lithium-ion batteries.

This process comprises an opening phase 1, which involves the discharge 1a, and the opening of the battery 1b, which can be carried out under safety conditions (verification of charge resetting, use of fume hood, explosion protection systems, etc.).

The zeroing of charge 1b preferably takes place by immersing the battery in an aqueous solution with NaCl.

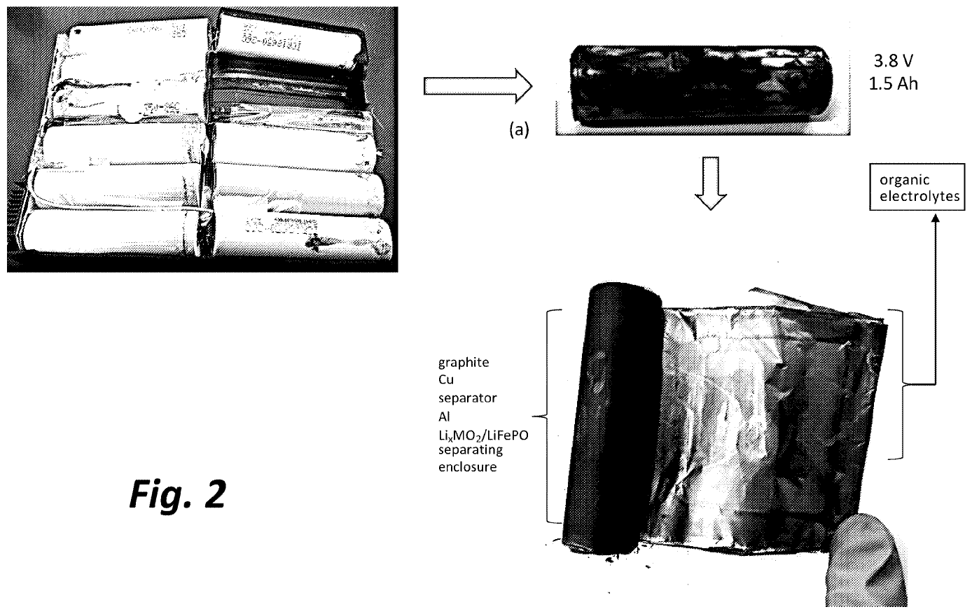

After the opening step 1, the various components were identified: cathode material (CM), anode material (AM), polyethylene separator (PE), copper foil (Cu) onto which the AM is adhered, and aluminum foil (Al) onto which the CM is generally adhered with an adhesive (FIG. 2), preferably said adhesive is polyvinylidene difluoride (PVDF).

In separation step 2, the copper was separated from the other components, which are generally called by-products.

Following the separation step 2, there is a size reduction step 3, carried out for example by crushing, which involves the size reduction of the by-product, which is then placed in aqueous solution in the leaching step 4.

The leaching step 4 comprises introducing the dimensionally reduced by-product into an aqueous solution additivated with natural organic acids, preferably with a concentration 1.5 M and recovery reducing agents, said aqueous solution and by-product being agitated in a container preferably for a time between 30 minutes and 60 minutes at a temperature between 25° C. and 90° C., preferably 80° C., so as to obtain a leaching solution. Advantageously, the leaching step 4 is assisted by sonication with ultrasound and/or microwaves improving the leaching efficiency as will be illustrated below in a preferred case study.

Alternatively, such natural organic acids can be introduced at concentrations between 0.9 M and 1.2 M to speed up the process for the same yield.

In order to separate the by-product glue and PE, a centrifugation step 5 of the leaching solution is performed, followed by an initial filtration step 6 to remove solid residues from the leaching solution.

Downstream of filtration, the process involves three consecutive precipitation steps 7, 9, 10 for the extraction of metals: a first precipitation step 7 which involves raising the pH of the leaching solution to 12 through the addition of KOH and holding the solution for between 20 minutes and 40 minutes, preferably 30 minutes at a temperature of between 60° C. and 90° C., preferably 80° C., so as to obtain precipitates of Ni(OH)₂ and Mn(OH)₂ which are then filtered in a second filtration step 8.

A second precipitation step 9 in which the leaching solution is kept at pH=12 by dosing the KOH concentration appropriately, and to which pure ethanol is added in order to obtain precipitated Co(OH)₂ and supernatant, the Co(OH)₂ being recovered by centrifugation of the solution.

A third precipitation step 10 in which the supernatant obtained downstream of the second precipitation step 9 is insufflated with gaseous CO₂ to obtain Li₂CO₃ precipitate.

The recovering reducing agents used in leaching step 4 are derived from the drying and crushing of vegetable and/or fruit scraps, and these vegetable scraps are in particular artichoke and/or sea fennel scraps.

Alternatively, the recovery reducing agents used in leaching step 4 are artichoke waste, in particular artichoke leaves and orange peels.

Preferably, this container can be closed, alternatively it can be refluxed.

Preferably, said cathode material comprises compounds selected from the group consisting of Li, Ni, Co, Mn and their combinations.

Preferably, this anodic material comprises mainly Cu.

According to some preferred embodiments of the process, the leaching step 4 is carried out starting from an aqueous solution comprising by-product and water in a constant volumetric ratio of 1:10, a weight ratio of recovery reducing agent to by-product of 1:5 preferably using ultrasound at a temperature of 80° C. for 60 minutes, a citric acid concentration of 0.5 M or 1 M or 1.5 M, i.e. within a range of 0.5 M to 1.5 M, and where the reducing agent of recovery is the artichoke residue.

According to other preferred embodiments of the process, the leaching step 4 is carried out starting from an aqueous solution comprising by-product and water in a constant volumetric ratio of 1:10, a weight ratio of recovery reducing agent to by-product of 1:5 preferably using ultrasound at a temperature of 80° C. for 60 minutes, a citric acid concentration of 0.5 M or 1 M or 1.5 M, i.e. within a range of 0.5 M to 1.5 M, and where the recovering reducing agent is sea fennel residue.

According to further preferred embodiments of the process, the leaching step 4 is carried out starting from an aqueous solution comprising by-product and water in a constant volumetric ratio of 1:10, a weight ratio of recovery reducing agent to by-product of 1:5 preferably using ultrasound at a temperature of 80° C. for 60 minutes, a citric acid concentration of 0.5 M or 1 M or 1.5 M, i.e. within a range of 0.5 M to 1.5 M, and where the recovering reducing agent is artichoke residues and orange peels.

Preferably, naturally occurring organic acids are selected from the group consisting of citric acid, acetic acid, maleic acid, oxalic acid, L-ascorbic acid, succinic acid, quinic acid, isocitric acid, tannic acid, caffeic acid, lactic acid, formic acid, uridic acid, barbituric acid, benzenesulphonidic acid, benzoic acid, bromacetic acid, chloroacetic acid, fumaric acid, gallic acid, phthalic acid, propionic acid, salicylic acid, sorbic acid, butyric acid and mixtures of these.

Preferably, filtration steps 6, 8 take place via a nylon membrane with a mesh size of 0.45 μm.

Preferably, in the precipitation steps, the KOH introduced is in pellet form.

Preferably, in the second precipitation step 9, ethanol, preferably pure ethanol, is introduced at a volume ratio of 1:10 between volume of pure ethanol and volume of leachate and the leaching solution is kept at 80° C. for about 12 hours.

Furthermore, the precipitate of Co(OH)2 obtained in the second precipitation step 9 is preferably washed repeatedly with ultra-pure water, and then dried at 60° C.

Finally, in the third precipitation step 10 the leaching solution can be a basic KOH solution with pH=12 and the gaseous CO₂ is blown at a temperature of 25° C. with a microbubble generator at a controlled flow rate.

The following is a preferred case study comprising performance data on the process of extracting metals from lithium-ion batteries according to the invention, also in comparison with some state-of-the-art data.

### EXAMPLES

In a preferred case study, a battery type ICR18650-26C was identified as the object of the study activities.

After opening, the various components were identified: cathode material (CM), anode material (AM), polyethylene separator (PE), copper foil on which the anode material (Cu) is adhered, and aluminum foil on which the cathode material (Al) is adhered (FIG. 1). The cathode material, in this case, is adhered with polyvinylidene fluoride (PVDF). (FIG. 2)

In the preferred case study, an aliquot of cathode and anode material as such was mechanically detached (scraped) from the metal foils and analyzed in the ICP-OES for its chemical composition (metal content and speciation). In addition, considering the difficulty of efficiently and quantitatively detaching the anodic and cathodic material from the aluminum foil and PE polymer separator, it was decided to cut these foils into fragments of approximately 5×5 mm and subject them directly to the chemical analysis process at ICP. Not included in this process was the copper foil, which was found to have no anodic material attached. The anodic material is usually graphite. Table 1 shows the results of the analytical determinations.

TABLE 1
Composition of anodic material (AM), cathodic material (CM)
and the mix identified as by-product or black matter (BM)
consisting of polyethylene foil (PE), anodic material (AM),
cathodic material (CM) and aluminium foil (Al).

| | | | BM (PE + |
|---|---|---|---|
| | AM | CM | AM + CM + Al) |
| Elements | % dw | % dw | % dw |
| Al | 0.33 | 0.03 | 5.13 |
| Co | 6.64 | 42.95 | 27.37 |
| Cu | 1.75 | 0.61 | 0.87 |
| Fe | 0.43 | 0.10 | 0.40 |
| Li | 1.61 | 6.05 | 4.80 |
| Mn | 0.01 | 0.00 | 0.00 |
| Ni | 0.03 | 0.02 | 0.02 |
| P | 0.98 | 0.43 | 0.34 |

Legend:
PE: Polyethylene Foil
AM: Anodic Material (Graphite)
CM: Cathodic Material (Litium and other cathodic components)
Al: Al Foil (Cathode)
Cu: Cu Foil (Anode)

The chemical composition of the cathode material (CM) shows that the battery used in the tests is of the LiCoO₂ type. In fact, a cobalt content of about 43% dw and a lithium content of 6.03% dw are observed. In addition, small amounts of nickel (0.02% dw) are present, while manganese is not detectable in the CM.

For the preferred case study, Table 2 shows the leaching efficiency results (LE %) obtained with the experimental conditions reported in Wu et al. (2020), thus considering: 5 g CM, 100° C. for 4 h, 1 g OP, 100 mL H3Cit 1.5M.

TABLE 2
Leaching efficiencies obtained by repeating the process
reported by Wu et al. (2020) on cathode material
(CM) and black mass BM (PE + AM + CM + Al)

| | CM | BM |
|---|---|---|
| | (Cit Ac OP Re TQ) | (Cit Ac OP Re TQ) |
| Metal | LE % | LE % |
| Al | — | 64.36 |
| Co | 91.30 | 84.24 |
| Li | 80.50 | 66.35 |
| Ni | 90.10 | 27.85 |

The leaching efficiency was evaluated for the various metals obtained by applying the following relationship:

$$LE = \frac{Conc . ( Co , Li , Ni , Al ) in the leached sample}{Conc . ( Co , Li , Ni , Al ) in aqua regia of starting sample} \times 100$$

From the analysis of the data, a confirmation of the leaching efficiencies reported by Wu et al. (2020) can be observed, using only the cathode CM as process input material. By applying the same leaching conditions on the by-product (PE+AM+CM+Al), also known as Black Mass (BM), a reduction in extraction efficiency and the passage of aluminum into solution is generally observed. In particular, the extraction efficiency for cobalt is reduced from 91.30% to 84.20%, for lithium from 80.50% to 66.35%, and for nickel (present in traces) from 90.10% to 27.85%. However, it must be pointed out that the reduction in LE for the most abundant elements (lithium and cobalt) is only a few percentage points. Moreover, this loss in LE can be clearly compensated for by the fact that one is working on a raw material input (the by-product) that can be realized and obtained by less complex and time-consuming technological processes (a simple grinding of the battery content) than those required to obtain the CM cathode material alone, separated from all other components.

The by-product (PE+AM+CM+Al) was preferably subjected to ultrasonic treatment under different experimental conditions of temperature, citric acid concentration, treatment time, and organic reducing agent to evaluate its leaching efficiency. For the preferred case study of the present invention, two new plant matrices besides orange peels were tested as reducing agents: powdered artichoke leaves and powdered sea fennel seeds (Crithmum maritimum).

These two matrices are found to be particularly rich in antioxidants, similarly to orange peels. Therefore, the organic reducing matrices tested were orange peels, artichoke leaves, and sea fennel. The solid:liquid (BM:solvent) ratio was kept constant at 1:10 weight:volume, while the weight ratio of organic reducing agent to BM was kept constant at 1:5 weight:weight (reducing agent/BM).

The mining conditions tested are shown and detailed in Table 3.

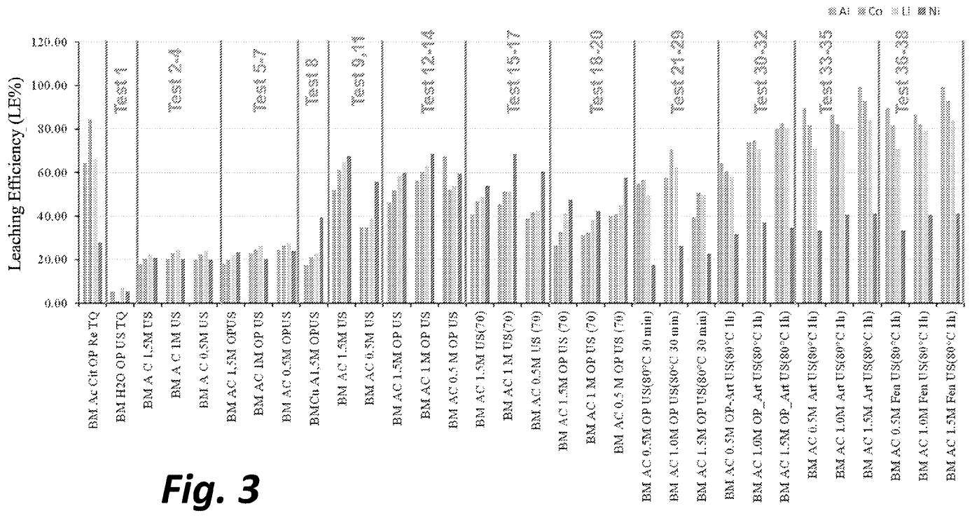

The leaching efficiencies (LE %) obtained in the trials performed (Table 3) are shown in FIG. 3. The highest LE values were observed in trials 33-35 and trials 36-38, in which the two new plant matrices were tested in the absence of orange peel (OP): powdered artichoke leaves and powdered sea fennel seeds. The extraction conditions preferably consisted of treatment with US at 80° C. for 1 h at three different levels of citric acid concentrations (AC 0.5, 1, 1-5 M). Tests were carried out at different concentrations of citric acid to see if the extraction process could be reduced. For both matrices, a high leaching efficiency of Co is observed, which is about 81% at 0.5M AC and reaches 93% at AC 1.5M. The leaching of lithium (Li) increases from 70% (0.5M AC) to 84% with AC 1.5M. The contribution of Ac concentration to the increase in leaching efficiency is thus evident.

TABLE 3
Experimental conditions used in ultrasound (US)-assisted leaching tests.

| | Extraction | Time | Temperature | | Extractant | Concentration | |
|---|---|---|---|---|---|---|---|
| Test | System | (h) | (° C.) | Sample | solution | (M) | Reductant |
| 1 | US | 1 | 25 | PE + AM + CM + Al | Water | 0 | Orange Peel |
| 2 | US | 1 | 25 | PE + AM + CM + Al | Citric Acid | 1.5 | — |
| 3 | US | 1 | 25 | PE + AM + CM + Al | Citric Acid | 1 | — |
| 4 | US | 1 | 25 | PE + AM + CM + Al | Citric Acid | 0.5 | — |
| 5 | US | 1 | 25 | PE + AM + CM + Al | Citric Acid | 1.5 | Orange Peel |
| 6 | US | 1 | 25 | PE + AM + CM + Al | Citric Acid | 1 | Orange Peel |
| 7 | US | 1 | 25 | PE + AM + CM + Al | Citric Acid | 0.5 | Orange Peel |
| 8 | US | 1 | 25 | PE + AM + CM + Al + Cu | Citric Acid | 1.5 | Orange Peel |
| 9 | Water Batch + US | 0.5 + 0.5 | 100 + 25 | PE + AM + CM + Al | Citric Acid | 1.5 | — |
| 10 | Water Batch + US | 0.5 + 0.5 | 100 + 25 | PE + AM + CM + Al | Citric Acid | 1 | — |
| 11 | Water Batch + US | 0.5 + 0.5 | 100 + 25 | PE + AM + CM + Al | Citric Acid | 0.5 | — |
| 12 | Water Batch + US | 0.5 + 0.5 | 100 + 25 | PE + AM + CM + Al | Citric Acid | 1.5 | Orange Peel |
| 13 | Water Batch + US | 0.5 + 0.5 | 100 + 25 | PE + AM + CM + Al | Citric Acid | 1 | Orange Peel |
| 14 | Water Batch + US | 0.5 + 0.5 | 100 + 25 | PE + AM + CM + Al | Citric Acid | 0.5 | Orange Peel |
| 15 | US | 1 | 70 | PE + AM + CM + Al | Citric Acid | 1.5 | — |
| 16 | US | 1 | 70 | PE + AM + CM + Al | Citric Acid | 0.5 | — |
| 17 | US | 1 | 70 | PE + AM + CM + Al | Citric Acid | 1.5 | — |
| 18 | US | 1 | 70 | PE + AM + CM + Al | Citric Acid | 1.5 | Orange Peel |
| 19 | US | 1 | 70 | PE + AM + CM + Al | Citric Acid | 1 | Orange Peel |
| 20 | US | 1 | 70 | PE + AM + CM + Al | Citric Acid | 0.5 | Orange Peel |
| 21 | US | 0.5 | 80 | PE + AM + CM + Al | Citric Acid | 0.5 | Orange Peel |
| 22 | US | 0.5 | 80 | PE + AM + CM + Al | Citric Acid | 0.5 | Orange Peel |
| 23 | US | 0.5 | 80 | PE + AM + CM + Al | Citric Acid | 0.5 | Orange Peel |
| 24 | US | 0.5 | 80 | PE + AM + CM + Al | Citric Acid | 1 | Orange Peel |
| 25 | US | 0.5 | 80 | PE + AM + CM + Al | Citric Acid | 1 | Orange Peel |
| 26 | US | 0.5 | 80 | PE + AM + CM + Al | Citric Acid | 1 | Orange Peel |
| 27 | US | 0.5 | 80 | PE + AM + CM + Al | Citric Acid | 1.5 | Orange Peel |
| 28 | US | 0.5 | 80 | PE + AM + CM + Al | Citric Acid | 1.5 | Orange Peel |
| 29 | US | 0.5 | 80 | PE + AM + CM + Al | Citric Acid | 1.5 | Orange Peel |
| 30 | US | 1 | 80 | PE + AM + CM + Al | Citric Acid | 0.5 | Orange Peel + Artichoke |
| 31 | US | 1 | 80 | PE + AM + CM + Al | Citric Acid | 1 | Orange Peel + Artichoke |
| 32 | US | 1 | 80 | PE + AM + CM + Al | Citric Acid | 1.5 | Orange Peel + Artichoke |
| 33 | US | 1 | 80 | PE + AM + CM + Al | Citric Acid | 0.5 | Artichoke |
| 34 | US | 1 | 80 | PE + AM + CM + Al | Citric Acid | 1 | Artichoke |
| 35 | US | 1 | 80 | PE + AM + CM + Al | Citric Acid | 1.5 | Artichoke |
| 36 | US | 1 | 80 | PE + AM + CM + Al | Citric Acid | 0.5 | Sea Fennel |
| 37 | US | 1 | 80 | PE + AM + CM + Al | Citric Acid | 1 | Sea Fennel |
| 38 | US | 1 | 80 | PE + AM + CM + Al | Citric Acid | 1.5 | Sea Fennel |

The co-presence of OP with artichoke leaves (trials 30-32) results in a reduction in leaching efficiencies, which, for Co fall to 61% (0.5M AC) and 83% (1.5M AC), respectively; while for Li they fall to 58% (0.5M AC) and 80% (1.5M AC), respectively. The use of OP as the only organic reducing system generated the highest LE values in tests 9-11 and tests 12-14, in which a sequential heating treatment (at 100 C.° in a water bath for 30 minutes) and subsequent ultrasonic treatment at room temperature (25 C.° for 30 minutes) were performed. These LE results, however, are lower than the values obtained in tests 33-35 and 38-38 with different plant matrices.

In the absence of OP (tests 9-11), the highest efficiencies are observed when using citric acid at the highest concentration (1.5 M). Under these conditions, 61.08% Co, 64.89% Li and 67.52% Ni were leached. Decreasing the citric acid concentration to 0.5 M results in a drastic reduction in the extraction efficiency, which is 34.56% for Co, 38.94% for Li and 55.77% for Ni.

In the presence of OP (tests 12-14), the highest leaching efficiencies are observed when using citric acid at intermediate concentration (1.0 M). Under these conditions, 60.22% Co, 62.90% Li and 68.68% Ni were leached. At citric acid concentrations of 1.5 and 0.5 M, a reduction in leaching efficiency is observed under both conditions, highlighting a clear synergistic effect between citric acid and OP that would allow citric acid concertation to be reduced under the conditions tested, while maintaining leaching yields unchanged. When lowering the extraction temperatures to 70° C., keeping the ultrasound active for 60 minutes (tests 15-17), the extraction efficiency drops to 51.16% for Co, 51.58% for Li and 68.55% for Ni, using 1.0 M citric acid without OP.

The addition of OP, under the same US and temperature conditions (tests 18-20), appears to have a negative effect, generating a reduction in leaching efficiency to 40.91% for Co, 44.99 for Li and 57.56% for Ni, using 0.5 M citric acid.

Further decreasing the extraction temperature to 25° C. by keeping the ultrasound active for 60 minutes (tests 2-4, tests 5-7) results in a concomitant decrease in extraction efficiency of around 20-27% for all elements.

The liquid fraction, obtained from the ultrasonic-assisted leaching process at 80° C. for 1 h in the presence of OP (tests 30-32), artichoke (tests 33-35) and sea fennel (tests 36-38), is separated from the solid fraction by centrifugation and filtered through a 0.45 μm nylon membrane filter. Subsequently, sequential precipitation with KOH pellets is induced in order to first obtain precipitation of Mn(OH)₂ and Ni(OH)₂, if present in the battery composition, and then precipitation of Co(OH)₂.

In the first precipitation process, the pH of the solution is raised to 12 by slowly adding KOH pellets and brought to 80 C.° for 30 minutes in order to obtain the precipitation of Mn(OH)₂ and Ni(OH)₂. Under these pH conditions, the possible presence of Cu and Al does not generate co-precipitation processes due to the amphoteric nature of these two elements in the form of hydroxides, which are soluble under the alkaline conditions tested (pH=12).

Subsequently, the liquid fraction containing Co and Li in solution, separated by filtration at 0.45 μm, is subjected to a second precipitation process by maintaining the pH at 12 with KOH, adding pure ethanol at a ratio of 1:10, volume of ethanol:volume of leachate, and maintaining at 80° C. overnight. The magenta-colored precipitate, consisting of Co(OH)₂, is recovered by centrifugation, washed several times with ultra-pure H₂O (MilliQ), and dried at 60° C., while the supernatant is sent to the third precipitation step for Li recovery. ICP-OES analysis of the precipitate shows a degree of purity of the obtained Co(OH)₂ of about 90%, with the presence of Al, Cu and K impurities. The total Co recovery rate is around 75-85% of the Co content in the leachate.

The supernatant recovered from the second precipitation step is insufflated at room temperature, by means of a microbubble generator, with CO₂ gas (technical grade) at a controlled flow rate (e.g. flow of 0.04 LPM into a 15 mL solution). The injection of CO₂ gas into basic KOH solution (pH=12) generates the following reactions:

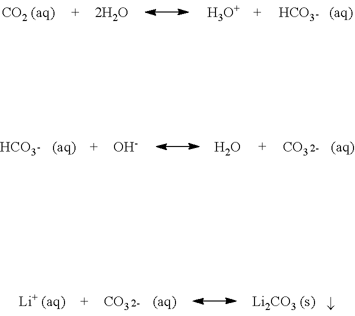

This results in the precipitation of lithium carbonate (Li2CO3), a white crystalline solid, which is then filtered at 0.45 μm and washed thoroughly with ultrapure water (MilliQ) to eliminate the presence of potassium. The precipitation of lithium carbonate is favored by its low solubility in water (13 g/L at 20° C.), compared to the high solubility of potassium carbonate K2CO3 (1120 g/L at 20° C.), which therefore remains in solution, generating selective precipitation. ICP-OES analysis of the precipitate shows a degree of purity of the obtained Li2CO3 of about 88%, with the presence of K and Co impurities. The total Li recovery rate is around 73-85% of the Li content in the leachate. The technique of recovering Li as carbonate and by blowing CO2, can also be considered an efficient CO2 storage system, one of the main greenhouse gases and the cause of current climate change.

1. Process (100) for the extraction of metals from lithium-ion batteries comprising:
1. an opening phase (1) comprising opening a battery (1a) and charge zeroing (1b) with immersion in an aqueous NaCl solution;
2. a separation step (2) comprising separating a copper element included in said battery from a by-product consisting of the rest of the battery components; said components being an adhesive, polyethylene, aluminum, cathode material, anode material;
3. a crushing stage (3) comprising size reduction of the by-product obtained in step (2);
4. a leaching step (4), assisted by sonication with ultrasounds and/or microwaves involving leaching of said dimensionally reduced by-product into an aqueous solution additivated with organic acids, selected from the group consisting of: citric acid, acetic acid, maleic acid, oxalic acid, L-ascorbic acid, succinic acid, quinic acid, isocitric acid, tannic acid, caffeic acid, lactic acid, formic acid, uridic acid, barbituric acid, benzenesulphonidic acid, benzoic acid, bromacetic acid, chloroacetic acid, fumaric acid, gallic acid, phthalic acid, propionic acid, salicylic acid, sorbic acid, butyric acid, and mixtures thereof, at a concentration between 0.5 M and 1.5 M and recovering reducing agents, said aqueous solution comprising said by-product and water in a constant volumetric ratio of 1:10, a weight ratio between recovery reducing agent and by-product equal to 1:5, said aqueous solution and said dimensionally reduced by-product being agitated in a container for between 30 minutes and 60 minutes at a temperature between 25° C. and 90° C., so as to obtain a leaching solution;
5. a centrifugation step (5) in which the adhesive and polyethylene are separated from the by-product;
6. a first filtration step (6) comprising removal of solid residues from the leaching solution;
7. a first precipitation step (7) comprising raising the pH of the leaching solution to 12 through the addition of KOH and maintaining the solution for between 20 minutes and 40 minutes at a temperature of between 60° C. and 90° C., in order to obtain precipitates of Ni(OH)₂ and Mn(OH)₂;
8. a second filtration step (8) to separate the Ni(OH)₂ and Mn(OH)₂ precipitates from the leaching solution;
9. a second precipitation step (9) in which the leaching solution is maintained at pH=12 by dosing the KOH concentration, and to which ethanol is added so as to obtain precipitated Co(OH)₂ and supernatant, the Co(OH)₂ being recovered by centrifugation of the solution; and
10. a third precipitation step (10) wherein the supernatant obtained downstream of the second precipitation step (9) is insufflated with gaseous CO₂ to obtain Li₂CO₃ precipitate;
wherein the reducing agents are derived from the drying and crushing of products of plant and/or fruit origin that have an effective amount of antioxidant phenolic compounds and/or reducing sugars.

2. The process (100) according to claim 1, wherein said plant and/or fruit products are at least one product selected from the group consisting of: artichoke, fennel, sea fennel, cabbage, carrot, asparagus, broccoli, clove, ginger, cinnamon, turmeric, mustard, curry, paprika, chilli, pepper, parsley, molasses, oregano, orange, lemon, blueberry, cherry, and strawberry.

3. The process (100) according to claim 1, wherein said products of plant origin are artichoke (Cynara cardunculus scolymus) and/or sea fennel (Crithmum maritimum) waste.

4. The process (100) according to claim 1, wherein said products of fruit origin comprise orange waste.

5. The process (100) according to claim 1, wherein said cathode material comprises mainly Li, Ni, Co, Mn, and wherein said anode material comprises mainly Cu.

6. The process (100) according to claim 1, wherein the leaching step (4) is carried out starting from an aqueous solution comprising said by-product and water in a constant volumetric ratio of 1:10, a ratio by weight of recovery reducing agent to by-product of 1:5, which includes the aid of ultrasonic sonication and/or microwaves, at a temperature of 80° C. for 60 minutes, and a citric acid concentration of between 0.5 M to 1.5 M and wherein said reducing agents comprise artichoke and/or sea fennel scraps, or orange peels.

7. The process (100) according to claim 1, wherein the filtration steps (6, 8) take place via a nylon membrane with a mesh size of 0.45 μm.

8. The process (100) according to claim 1, wherein, in the precipitation steps (7, 9, 10), the introduced KOH is in the form of pellets.

9. The process (100) according to claim 1, wherein ethanol is introduced at a volume ratio of 1:10 between volume of pure ethanol and volume of leachate and the leaching solution is maintained at 80° C. for about 12 hours.

10. The process (100) according to claim 1, wherein the precipitate of Co(OH)₂ obtained in the second precipitation step (9) is washed repeatedly with ultra-pure water, and subsequently dried at 60° C.

11. The process (100) according to claim 1, wherein in the third precipitation step (10) the leaching solution is a basic KOH solution with pH=12, and gaseous CO₂ is insufflated at a temperature of 25° C. with a microbubble generator at a controlled flow rate.
